(19) United States
(12) Patent Application Publication
(10) Pub. No.: US 2006/0253638 A1
(43) Pub. Date: Nov. 9, 2006

(54) System and method for enabling printing and charging of a mobile capture device via a docking device

(75) Inventors: Jason R. Oliver, Rush, NY (US); Neal Eckhaus, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/388,508

(22) Filed: Mar. 24, 2006

Related U.S. Application Data
(60) Provisional application No. 60/677,392, filed on May 3, 2005.

(51) Int. Cl. G06F 13/00

(52) U.S. Cl. 710/303

(57) ABSTRACT

Providing data transfer and charging operations for a mobile imaging device via a docking device. An electronic image capture and display device with telecommunications capabilities is enabled to print and charge while connected to a docking device by automatically determining a type of device coupled to a docking device, providing a device-controlled or a dock-controlled charging sequence based on the type of device, and charging a battery disposed in the type of device coupled to the docking device according to the charging sequence.

### CROSS REFERENCE TO RELATED APPLICATIONS

Reference is made to and priority claimed from U.S. Provisional Application Ser. No. 60/677,392, filed May 3, 2005, entitled SYSTEM AND METHOD FOR ENABLING PRINTING AND CHARGING OF A MOBILE CAPTURE DEVICE VIA A PRINTER DOCK.

### FIELD OF THE INVENTION

The present invention relates to enabling an electronic image capture and display device with telecommunications capabilities to print and charge while connected to a docking device.

### BACKGROUND OF THE INVENTION

FIG. 1A illustrates a prior art system for printing images at a docking device 12, such as a printer dock, from a digital camera having an appropriate connector. The docking device is capable of charging the camera when it is placed on the docking device. This system provides a utility to the user in that the camera is charged when not in use. Also, prints may be made from the images stored on the camera or the camera's removable memory device by directly connecting the camera to the docking device without an intervening device such as a computer. Further, the camera is easily located and at the ready whenever the user desires to use it for photography. However, this system only works for camera devices. Also, the functions of both printing and charging are only enabled when the camera has a connector matching the connector on the docking device.

Recently, cellular telephone devices have incorporated cameras. Initial attempts at this combination yielded photographic systems that were not well matched to making prints due to lack of resolution and other factors. However, these camera combinations continued to improve. Many manufacturers are producing Mobile Capture Communication Devices (MCCDs) that are capable of capturing images that are well suited for printing while also permitting telecommunication over a communication network.

Cellular Network Service Providers have sought to enable printing of images captured by MCCDs by transferring images via a cellular network to a server. From the server the images are transferred to either service providers that will print the images or to the user's personal computer for printing. This way of printing images is often not preferred because of the need to understand the user interface of the MCCD such that the images are sent to the appropriate place, the amount of time necessary for sending an image of resolution suitable for printing, and the fees charged for transmitting images from the MCCD to the location where the print is created. Additionally, the MCCD must use energy to transmit the images. Accordingly, by sending the images to the printer, the time the MCCD can be used between charging is reduced.

### SUMMARY OF THE INVENTION

In general terms the present invention relates to a docking device for providing printing and charging operations for a mobile capture device.

In one embodiment, a method for providing data transfer and charging operations for a mobile imaging device via a docking device is provided. The method includes automatically determining a type of device coupled to a docking device, providing a device-controlled or a dock-controlled charging sequence based on the type of device, and charging a battery disposed in the type of device coupled to the docking device according to the charging sequence.

In another embodiment, a device for providing data transfer and charging operations for a mobile imaging device is provided. The device includes a docking device to automatically determine a type of device coupled to the docking device, a processor disposed in the docking device to provide a device-controlled or a dock-controlled charging sequence based on the type of device, and a charger disposed in the docking device to charge a battery included in the type of device coupled to the docking device according to the charging sequence.

### BRIEF DESCRIPTION OF THE DRAWINGS

In the detailed description of the preferred embodiments of the invention presented below, reference is made to the accompanying drawings in which:

FIG. 1A is an exploded perspective view of a prior art docking system for a digital camera;

FIG. 1B is a perspective of the docking system of FIG. 1A illustrating a prior digital camera engaged with the docking device;

FIG. 2 is a schematic diagram of the electrical connection between the digital camera and docking device of FIGS. 1A and 1B;

FIG. 3 is a typical MCCD connector for the digital camera and docking device of FIGS. 1A and 1B;

FIG. 4 illustrates a docking device connector pin assignment for a typical prior art digital camera;

FIG. 5 illustrates the prior art system of FIGS. 1A and 1B with an adapter for allowing engagement with an MCCD;

FIG. 6 is a chart for determining camera and MCCD type in accordance with the present invention;

FIG. 7 illustrates logo screens for an MCCD in accordance with the present invention;

FIG. 8 shows the printer dock receiving a firmware upgrade via the MCCD with a status message in accordance with the present invention;

FIG. 9 is a flow chart illustrating placing a printer order prior to docking of the MCCD;

FIG. 10 illustrates a phone list printed on 4″ by 6″ print with an easily readable number of phone numbers as taken from a data file on an MCCD;

FIG. 11A is plan view of a coupon that was printed by the docking device in response to a print command generated by the MCCD;

FIG. 11B illustrates various functionality of a digital camera and docking device;

FIG. 11C illustrates various functionality in a tethered system; and

FIG. 11D illustrates various functionality of the MCCD and docking device in accordance with the present invention.

### DETAILED DESCRIPTION OF THE INVENTION

Various embodiments will be described in detail with reference to the drawings, wherein like reference numerals represent like parts and assemblies throughout the several views. References to various embodiments does not limit the scope of the invention, which is limited only by the scope of the claims attached hereto. Additionally, any examples set forth in this specification are not intended to be limiting and merely set forth some of the many possible embodiments for the claimed invention.

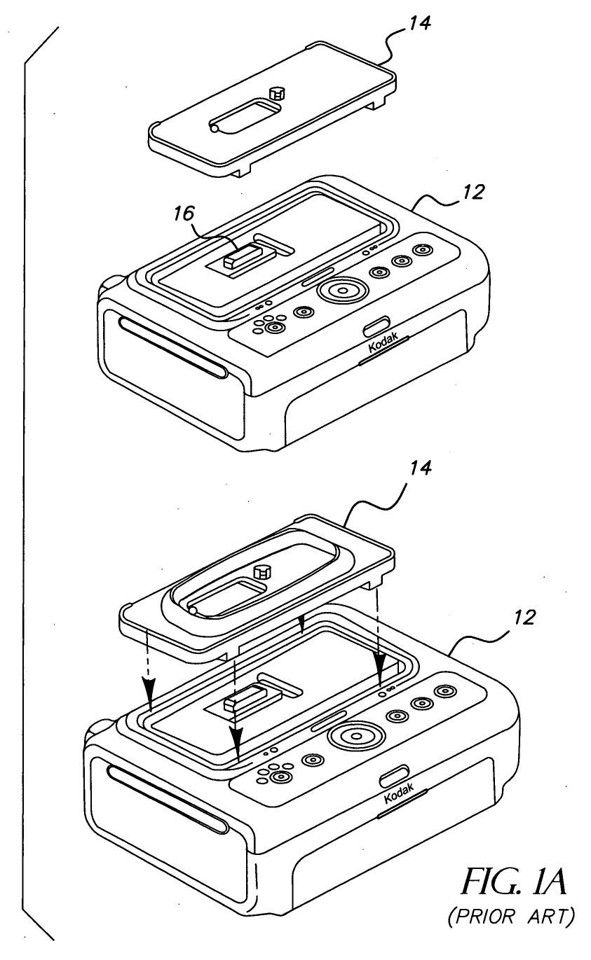

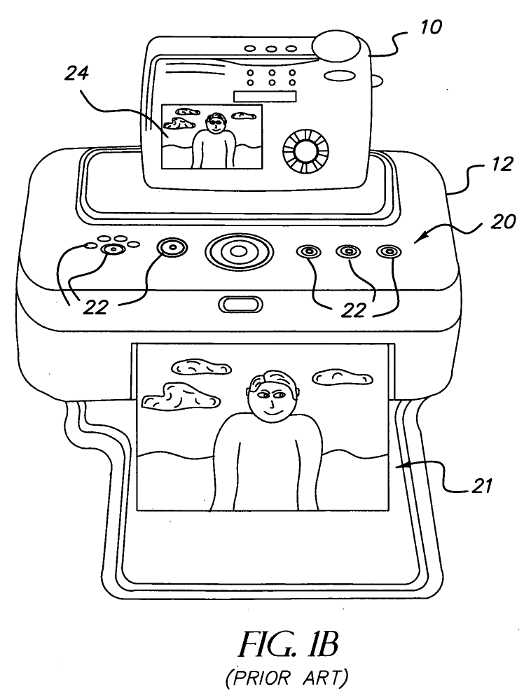

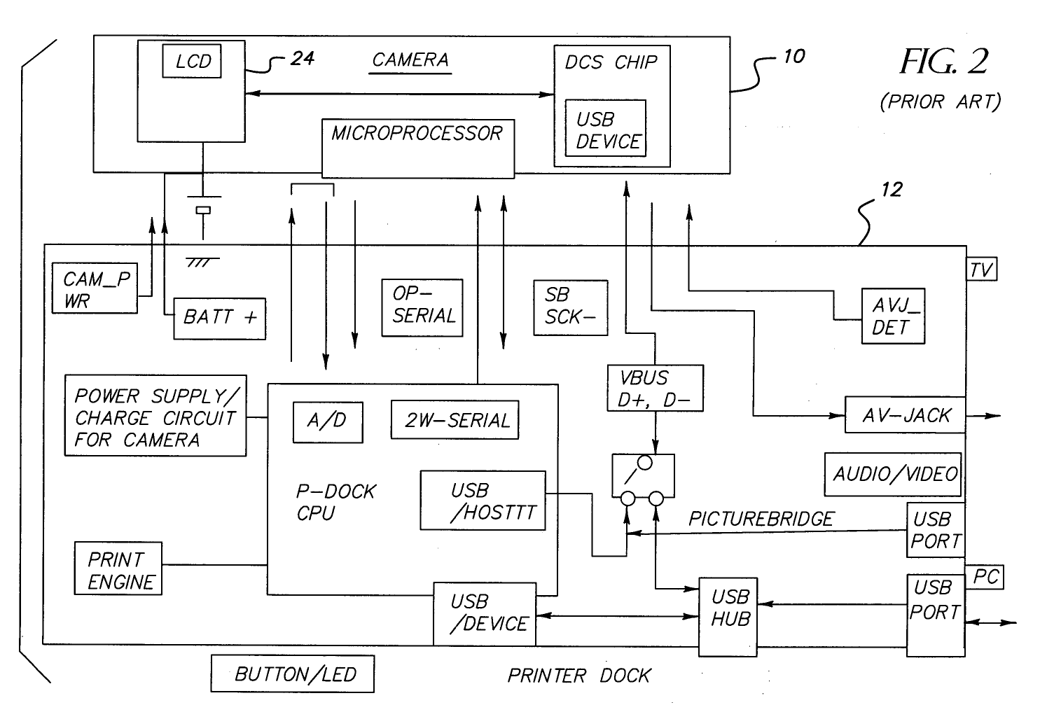

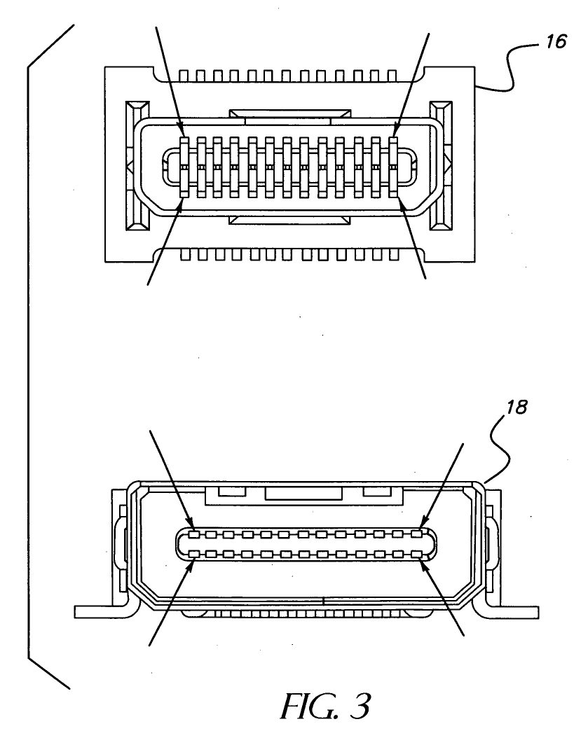

FIGS. 1-3 illustrate a prior art digital camera 10 and docking device 12, such as a printer dock. An appropriate mounting plate 14 is provided for allowing proper mounting of the digital camera 10 with the docking device 12 so that a dock connector 16 will properly engage a camera socket 18. When properly mounted, control interface 20 on the docking device 12 allows printing of prints 21 from images stored on digital camera 10. The control interface 20 typically comprises a plurality of selection buttons 22 that control printing. Also, the display 24 on camera 10 can be used for viewing images stored on the camera that can be selected for printing on the docking device 12.

The physical interface between a digital camera 10 and a docking device 12 must match to properly enable the interface. In the prior art, the digital camera has a number of contacts that mate with the connector on the docking device. The dock connector 16 and camera socket have many contacts and alot of redundancy as shown in FIG. 3.

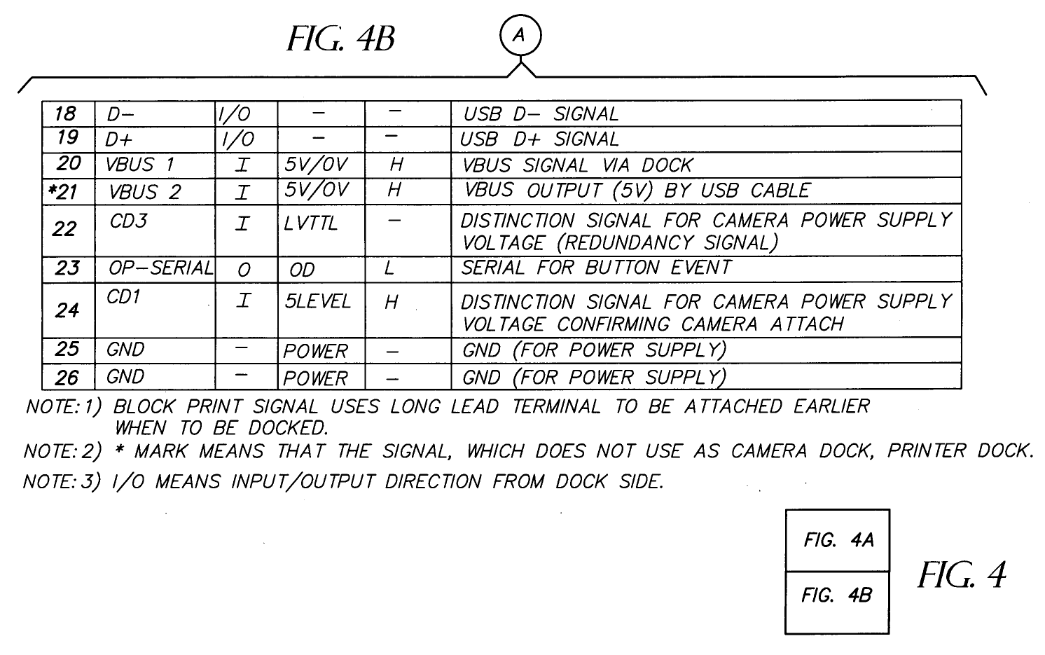

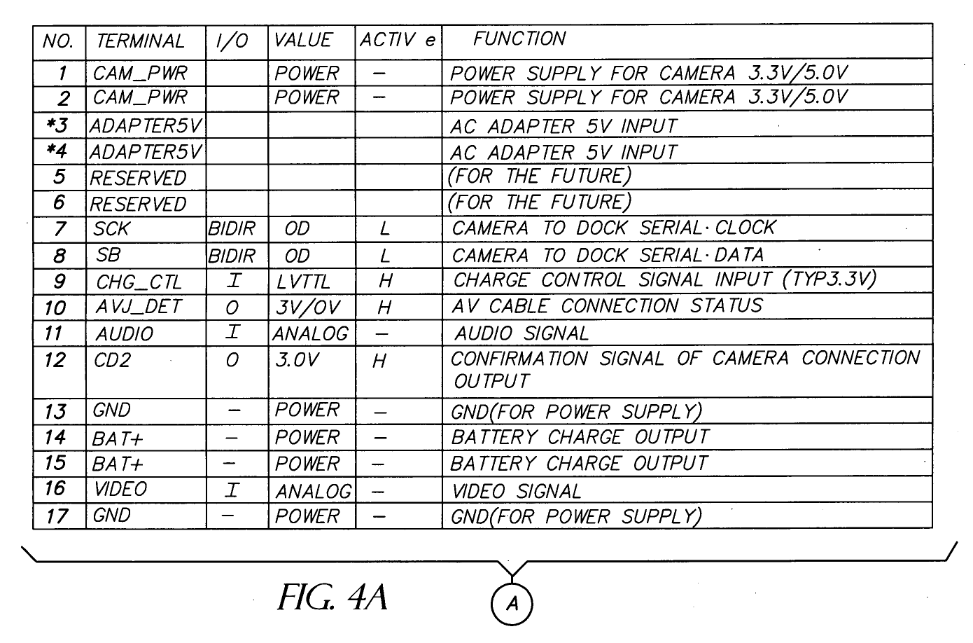

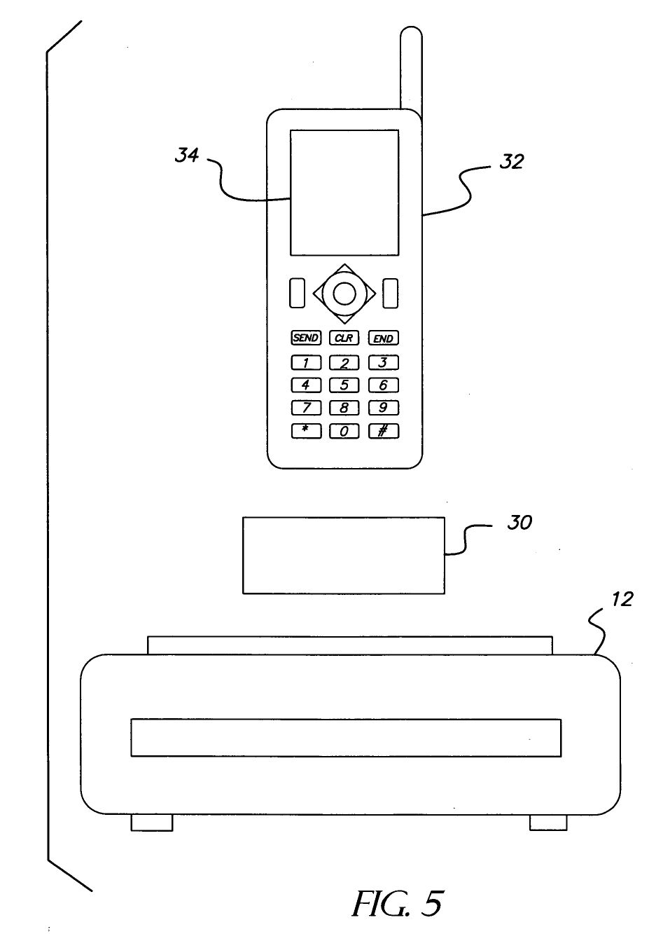

FIG. 4 is one embodiment that illustrates the function of the various pins on the dock connector 16 that can connect to a socket 18 of digital camera 10 of MCCD 32 (as shown in FIG. 5).

FIG. 5 illustrates a physical interface/adapter 30 that must be provided to make a proper connections between the MCCD 32 and the docking device 12.

In addition to the physical differences discussed above, the docking device 12 must also be able to distinguish between cameras and MCCDs. Also, the docking device 12 must be able to distinguish between differing MCCDs for power and communications needs. For example, not all MCCDs charge with the same voltage.

The docking device 12 can provide different voltages to a camera or MCCD 32 and must be able to discern which voltage to supply. As described in ImageLink for Mobile Capture Devices Specification V0.1 preliminary engineering specification, a resistance supplied is between pins CD1 and CD2 (not shown) of the MCCD, which is used to determine a desired charging voltage. Voltage is applied to CD2 and a voltage detected at a resistive divider at CD1 is used to determine an applied charging voltage.

In one embodiment, the presence of an MCCD 32 is detected by use of a 1K resistor across CD1 and CD2. Voltage is applied to CD2 and the detected voltage of the resistive divider at CD1 is used to determine the presence of an MCCD. Once the presence of the MCCD has been detected, the logic level of CD3 is used to determine what charging voltage to supply. If the logic level at CD3 is low, 3.3V is applied for charging. If the logic level at CD3 is high, 5.0V is applied for charging. By this, the docking device 12 is enabled to provide charging voltage to cameras and MCCDs.

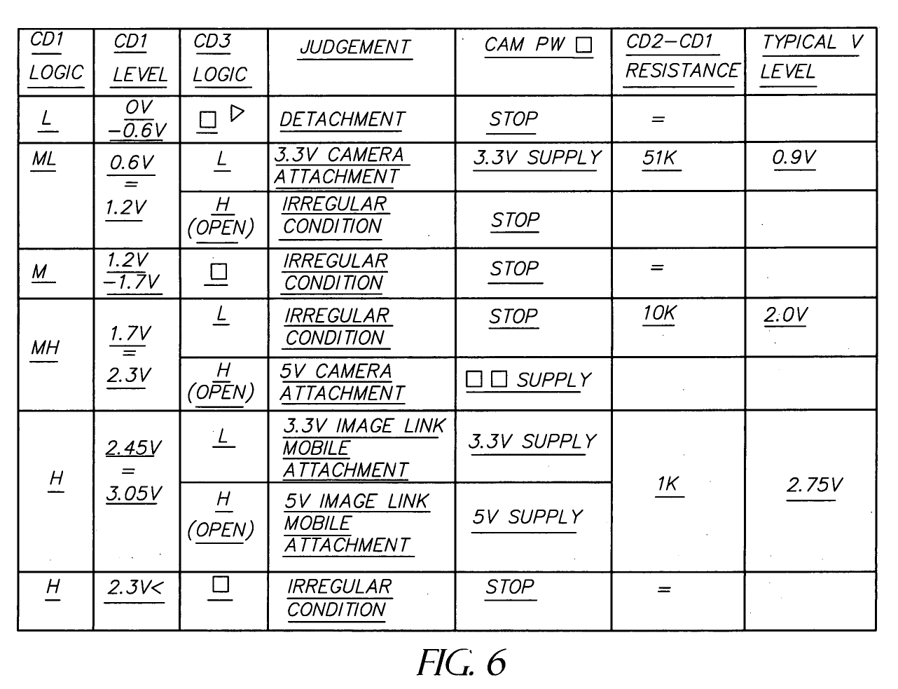

FIG. 6 illustrates a chart for determining the difference between a camera and MCCD. In the case of the prior art for cameras, the resistance is specified as 51Kohms for 3.3V charging and 10Kohms for 5.0V charging. These conditions are verified by the logic level at CD3, with a low level corresponding to the 3.3V charging situation, and a high level corresponding to the 5.0V charging situation. If the detected voltage at CD1 and the logic level at CD3 do not correspond to the same charging situation, the condition is illegal and no charging voltage is applied.

Accordingly, the docking device 12 can automatically determine the type of docked device and provide the proper voltage to power and charge the connected device whether the connected device be an MCCD 32 or digital camera 10. The docking device 12 can automatically provide dock-controlled or device-controlled recharging sequences. The docking device 12 can automatically determine the device type even if the device battery has been exhausted. This determination occurs without addition or modification to the device being engaged to the docking device 12, and without user intervention. Also, the docking device 12 can access images and data from the MCCD 32 even if the MCCD battery has been exhausted or the MCCD 32 has no battery.

The docking device must be able to communicate with the user for efficient operation. Flashing LEDs on the docking device provide for some minimal communication, but for many operations, a textual display is required. In the prior art, a docking device 12 sends text to the camera 10 in a well-defined manner similar to the well-known HTML (HyperText Markup Language). In communicating with an MCCD 32, a display 34 varies widely, and MCCD 32 is designed to be capable of formatting text to its specific display so it is unnecessary and tedious to send messages in such a well-defined manner. In contrast to the prior art, docking device 12 sends only the content of the messages to the MCCD 32 where the content is formatted appropriately for display on display 34. The decision of whether to send formatted content or only content is based on the type of device detected (camera or MCCD).

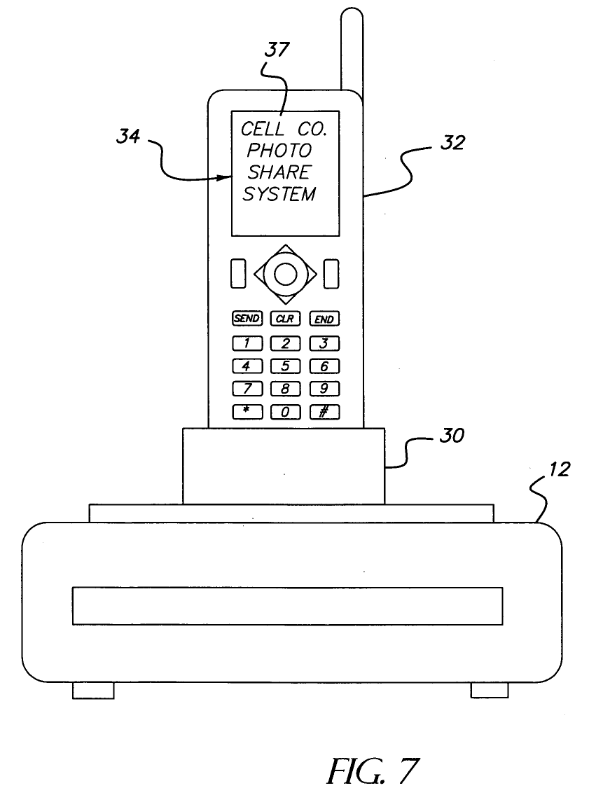

FIG. 7 illustrates log screens for an MCCD in accordance with the present invention. Different MCCDs or service providers/manufacturers may wish to interpret commands from the docking device 12 differently. This is supported where different MCCDs are able to interpret the same docking device generated message differently. In FIG. 7, a start up logo 37 appears on display 34 when the MCCD 32 is first attached to the docking device 12. The logo 37 can include the manufacturer's specific logo or model, or the logo of the cellular service provider for the MCCD 32. The logo 37 displayed on display 34 can be enabled by a command from the docking device 12 to display the file logo.jpg, which resides on the MCCD 32, and is only displayed when the MCCD 32 receives the call for logo jpg. Accordingly, in one embodiment, the system displays a device specific logo in response to a call from the docking device 12. Further, different logos for different MCCDs are displayed by a single generic call.

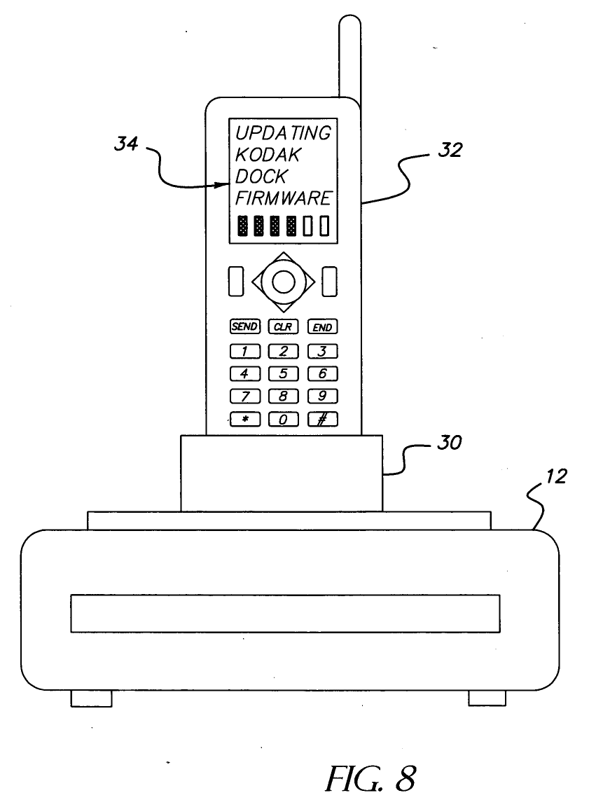

FIG. 8 shows the docking device 12 receiving a firmware upgrade via the MCCD 32. The connection of a telecommunication-enabled device, such as an MCCD 32, to the docking device 12 enables the docking device 12 to receive firmware updates from remote sources via a telecom link. Upon determining that an MCCD 32 has been connected, the docking device 12 can request an update or other data via a connection to a remote server via MCCD telecommunication capabilities. Messages indicating the status of the data transfer can be shown on the MCCD display 34. Alternatively, MCCD 32 can initiate the firmware upgrade when it detects a connection to docking device 12.

In one embodiment the MCCD 32 is handled differently than a camera 10. When a communication is interrupted, some accommodation must be made for handling the interruption. In the prior art digital camera, if communication is interrupted, an executed print order is terminated by the docking device and the process must be reinitiated. In one embodiment of the present invention, when the MCCD 32 responds to an incoming call, a single image being transferred for printing from the MCCD 32 to the docking device 12 is terminated in the same manner as the prior art. However, if the MCCD creates a DPOF (Digital Print Order Format) file as taught by Parulski in U.S. Pat. No. 6,812,962 or uses some other method of creating a print order and the order is interrupted partway through transfer, some accommodation must be made for handling of the order. Either the docking device 12 or the MCCD 32 or both can have the responsibility for determining how to resume the order.

In one scenario, the docking device 12 does not print until the entire order is received. This is undesirable due to memory constraints in the docking device 12 and also due to the long delay to first print. In one embodiment, the MCCD 32 determines the files that have been transferred completely and reinitiates transfer with the files that have not been transferred. This allows for printing as the images are received and also for printing of transferred files that have been received in full even while the MCCD 32 is removed from docking device 12 or is being used for a function unrelated to printing.

The MCCD 32 also has access to information in forms other than imagery. For example, there are often lists of phone numbers (often referred to as an address list or contact list) stored in the MCCD 32. It may be desirable for such a list and associated data to be printed. In this case, the MCCD 32 formats textual or other non-image data types into a format such as a JPEG image that the printer can accept. The MCCD 32 can use information acquired from the docking device 12 to properly format the image in terms of resolution, aspect ratio, needs specific to content or other specifications so that a pleasing and useful print is created.

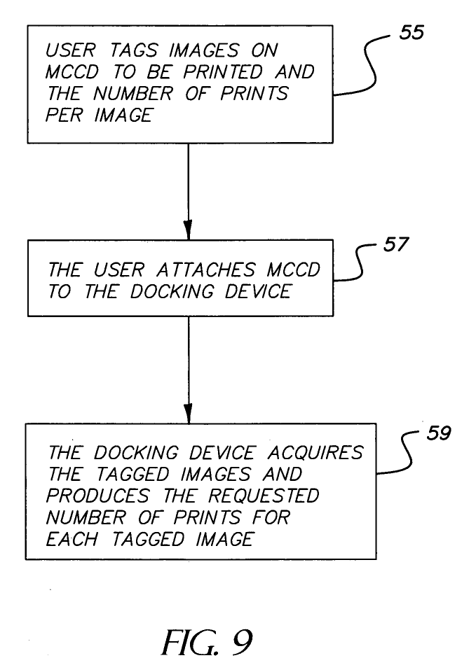

FIG. 9 is a flow chart illustrating placing a printer order prior to docking of the MCCD according to one embodiment. In FIG. 9, using an MCCD a user can tag images to be printed 55. The user then connects the MCCD to a docking device 57. The connection can be either physically placing the MCCD in the docking device or placing the MCCD as to allow a wireless connection to be established. The docking device can then acquire the tagged images. After the images are acquired, a requested number of prints can be produced. For example, one or more of each tagged print can be produced by the docking device. However, the invention is not limited to producing prints on the docking device, and any suitable deice can be used. For example, the docking device can be coupled to a communication network in which a remote service provider can receive and print the tagged images.

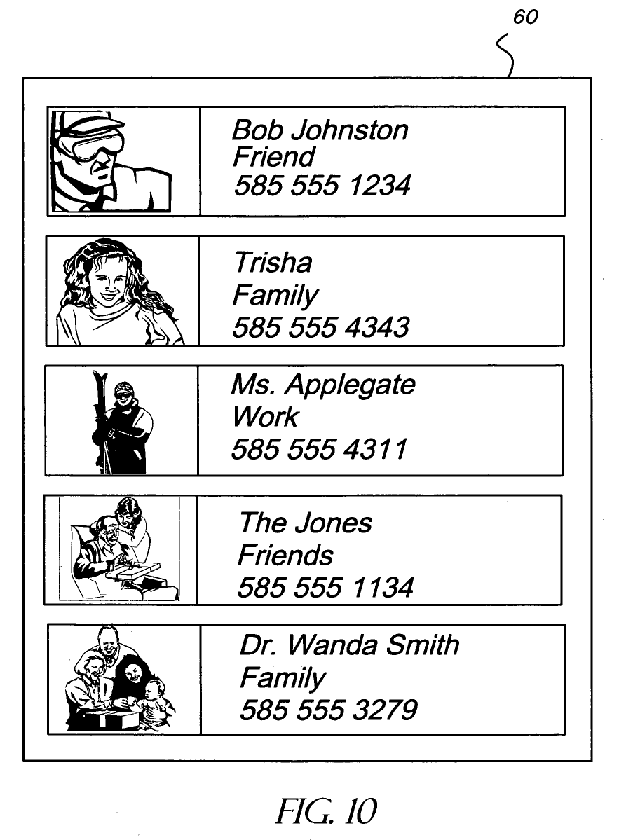

As shown in FIG. 10, if a phone list is to be printed, and the docking device 12 is limited to creating 4″ by 6″ prints, the phone list can be formatted so that an easily readable list 60 of phone numbers is printed on each print. The docking device 12 can also have the capability to upload this received data/information back into the MCCD from which it came or into another unrelated MCCD or device, such as a digital camera.

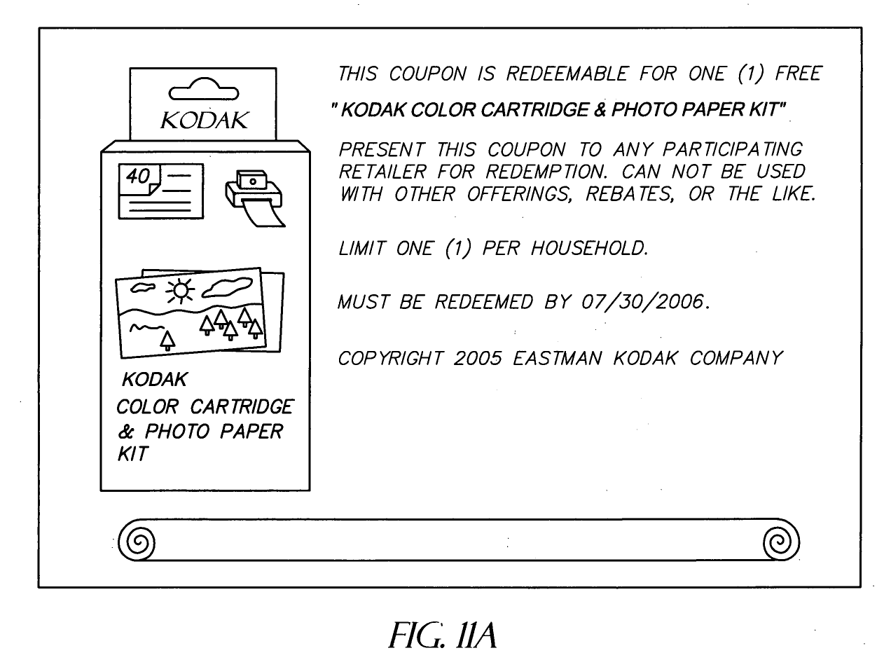

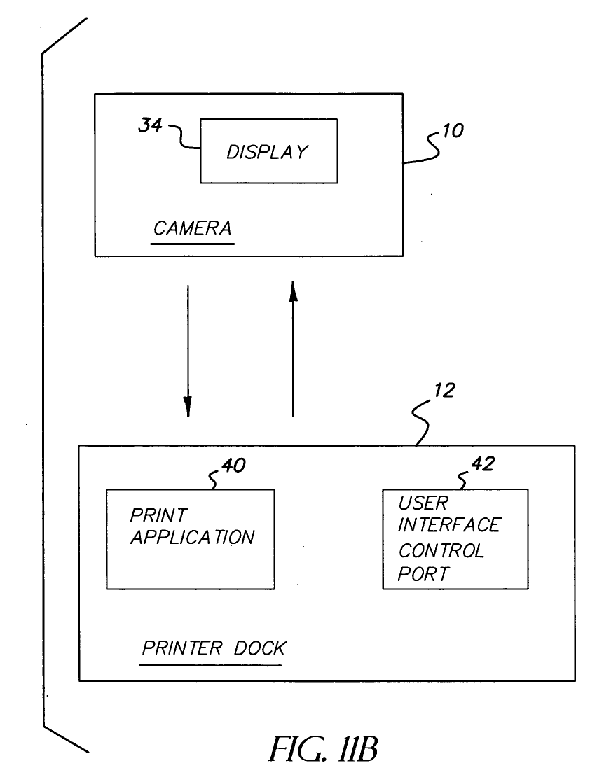

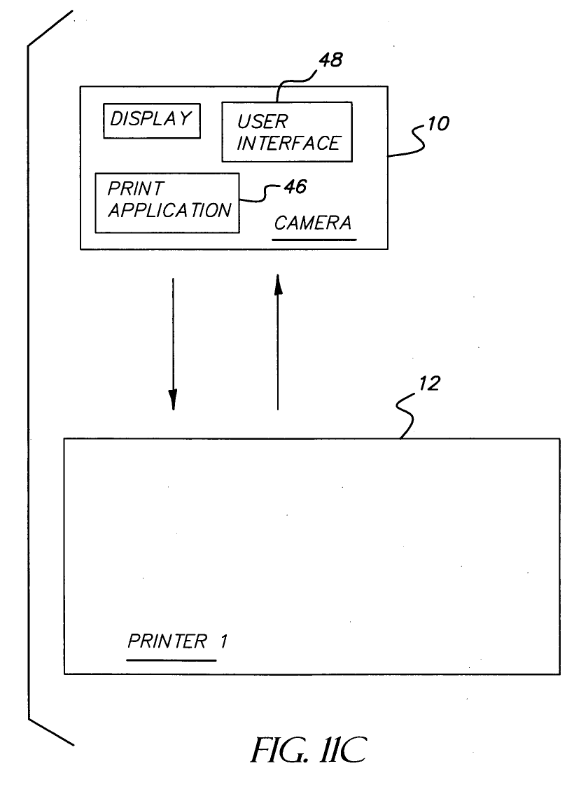

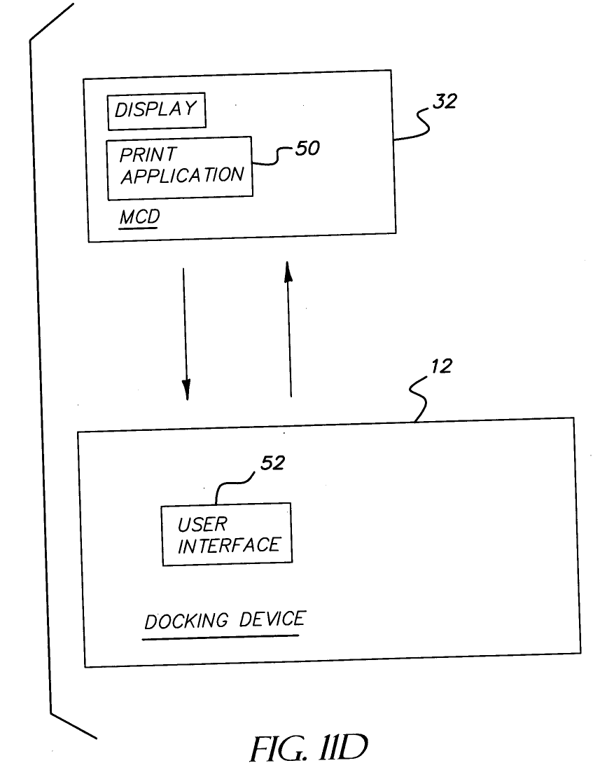

The MCCD 32 can also store images for limited printing. FIG. 11A shows a coupon that is printed by the docking device from a file stored in the MCCD 32. In this case, the coupon is a one-time offer. The MCCD will only transfer the image file in question when connected to docking device 12. Immediately after transferring the image file from the MCCD 32 to the docking device, the MCCD 32 deletes the file so that the coupon cannot be reprinted.

FIG. 11B illustrates the various functions in the digital camera 10 and docking device 12. In a prior art docking device 12, the print application 40, and control point 42, also known as the user input mechanism or user interface, reside on the docking device 12. The primary user feedback mechanism, which is the display 34 capable of showing images, graphics and textual information, resides on the docked device, i.e. camera 10.

FIG. 11C illustrates a tethered configuration. In the tethered system taught by the PictBridge standard from CIPA (Camera and Imaging Products Association), the print application 46, control point 48, and primary user feedback mechanism reside on the tethered device, e.g. digital camera 10.

FIG. 11D shows the system architecture for the present invention including an MCCD 32 and docking device 12. The print application 50 and primary user feedback mechanism reside on the docked device, in this case the MCCD 32. The control point 52 resides on the docking device 12. This configuration provides the advantage of insuring that the print application is appropriate to MCCD 32 while maintaining the control point 52 on docking device 12.

The various embodiments described above are provided by way of illustration only and should not be construed to limit the invention. Those skilled in the art will readily recognize various modifications and changes that can be made to the present invention without following the example embodiments and applications illustrated and described herein, and without departing from the true spirit and scope of the present invention, which is set forth in the following claims.

1. A method for providing data transfer and charging operations for a mobile imaging device via a docking device, the method comprising:
automatically determining a type of device coupled to a docking device;
providing a device-controlled or a dock-controlled charging sequence based on the type of device; and
charging a battery disposed in the type of device coupled to the docking device according to the charging sequence.

2. The method of claim 1, wherein automatically determining the type of device further comprises determining the difference between a camera and an MCCD by the docking device for applying a proper charging voltage.

3. The method of claim 2, wherein determining the difference between the camera and the MCCD further comprises transmitting a command from the docking device that is interpreted differently by the camera and the MCCD.

4. The method of claim 2, wherein determining the difference further comprises determining a display format of a display on the MCCD and uses the display format for displaying information on a display.

5. The method of claim 4, wherein the transmitting a command further comprises transmitting the content of messages to the display.

6. The method of claim 2 further comprising accessing digital images on the MCCD.

7. The method of claim 2 further comprising utilizing the communication capabilities of the MCCD to obtain information.

8. The method of claim 2 further comprising operating the MCCD by a user while the MCCD is coupled to the docking device.

9. The method of claim 1, wherein charging the battery further comprises automatically determining a voltage requirement for the type of device by measuring resistance across electrical contacts for the type of device.

10. The method of claim 1, wherein automatically determining the type of device further comprising automatically determining the type of device even when the battery has been exhausted.

11. The method of claim 1 further comprising downloading a digital file from the MCCD to the docking device.

12. The method of claim 1 1, wherein downloading the digital file further comprises downloading a digital image file.

13. The method of claim 11, wherein downloading the digital file further comprises downloading a data file.

14. The method of claim 13, wherein downloading the data file comprises downloading the data file including an address list.

15. The method of claim 13, wherein downloading the data file further comprises restoring the data file to the MCCD by the docking device.

16. The method of claim 1 further comprising connecting to a communication network for transmitting or receiving data by the docking device.

17. The method of claim 16, wherein connecting to a communication network further comprises receiving information by the docking device over the communication network for use in communicating with an MCCD.

18. A device for providing data transfer and charging operations for a mobile imaging device, comprising:
a docking device to automatically determine a type of device coupled to the docking device; and
a processor disposed in the docking device to provide a device-controlled or a dock-controlled charging sequence based on the type of device; and
a charger disposed in the docking device to charge a battery included in the type of device coupled to the docking device according to the charging sequence.

19. The device of claim 18, wherein the type of device further comprises one of a camera or a MCCD.

20. The device of claim 18, wherein the docking device automatically determines a voltage requirement for the type of device by measuring a resistance across electrical contacts of the type of device.

21. The device of claim 19, wherein the docking device automatically determines the type of device even when the battery has been exhausted.

22. The device of claim 19, wherein the docking device includes a system to access digital images on the MCCD.

23. The device of claim 19, wherein the docking device further comprises a system to determine a display format of a display on the MCCD.

24. The device of claim 23, wherein the docking device forwards content for viewing on the display.

25. The device of claim 19, wherein a digital file is downloaded from the MCCD to the docking device.

26. The device of claim 25, wherein the digital file further comprises a digital image file.

27. The device of claim 25, wherein the digital file further comprises a data file.

28. The device of claim 27, wherein the data file further comprises an address list.

29. The device of claim 27, wherein the docking device includes a memory for storing the data file and to restore the data file to the MCCD.

30. The device of claim 18, wherein the docking device is capable of connecting to a communication network to transmit or receive data.

31. The device of claim 30, wherein the docking device obtains information over the communication network for use in communicating with an MCCD.

32. The device of claim 19, wherein the docking device uses communication capabilities of the MCCD to obtain information.

33. The device of claim 32, wherein the docking device uses communication capabilities of the MCCD to update firmware on the docking device.

34. The device of claim 19, wherein a user can use the MCCD while the MCCD is coupled to the docking device.

35. The device of claim 18, wherein the docking device is a Kiosk.

36. The device of claim 19, wherein the MCCD tracks image transfer and resumes the image transfer after an image transfer interruption.

37. The device of claim 19, wherein the MCCD formats non-image files to print on a plurality of different output devices.

38. The device of claim 19, wherein the MCCD deletes a non-image file after a predetermined number of prints are executed.

39. The device of claim 19, wherein the docking device provides control to execute operation performed on the MCCD.
